(19) United States
(12) Patent Application Publication
(10) Pub. No.: US 2025/0377843 A1
(43) Pub. Date: Dec. 11, 2025

(54) IMAGE FORMING SYSTEM, IMAGE FORMING APPARATUS, AND CONTROL METHOD FOR IMAGE FORMING SYSTEM

(71) Applicant: SHARP KABUSHIKI KAISHA, Sakai City (JP)

(72) Inventor: Rika ICHIU, Sakai City (JP)

(21) Appl. No.: 19/218,840

(22) Filed: May 27, 2025

(30) Foreign Application Priority Data
Jun. 5, 2024 (JP) 2024-091729

(51) Int. Cl. G06F 3/12

(52) U.S. Cl. CPC G06F 3/1253; G06F 3/1205; G06F 3/126; G06F 3/1285

(57) ABSTRACT

An image forming system includes a plurality of groups, to each of which one or more image forming apparatuses operating as parent devices and one or more image forming apparatuses operating as child devices belong, and performs image forming using the image forming apparatus belonging to a group of the plurality of groups configured. The image forming system includes a display that displays a basic screen receiving an instruction to operate the image forming apparatus, and one or more controllers that control a screen display of the basic screen. The one or more controllers display on the basic screen a switching key receiving an instruction to switch to the group designated by a user, and output from the child device a print image based on a print job registered in the parent device belonging to the group after switching.

### CROSS-REFERENCE TO RELATED APPLICATION

The present application claims priority from Japanese Application JP2024-091729, the content of which is hereby incorporated by reference into this application.

### BACKGROUND OF THE INVENTION

### 1. Field of the Invention

The present disclosure relates to an image forming system, an image forming apparatus, and a control method for an image forming system.

### 2. Description of the Related Art

For example, some image forming apparatuses such as multi-function printers implement a function of outputting a print job registered in an image forming apparatus operating as a parent device, in an image forming apparatus operating as a child device (hereinafter, the function is referred to as a print release function).

Such a print release function may include, with a plurality of groups to which the parent devices and the child devices belong provided, an extension function (connection destination group linking function) capable of seeking linkage with a group other than a group used for processing of a normal print job.

For example, the related art discloses that a plurality of groups including a plurality of printers can be created, and switched between and displayed on a user interface (UI) screen of a print server.

### SUMMARY

An object of an aspect of the present disclosure is to provide an image forming system, an image forming apparatus, and a control method for an image forming system capable of easily switching a group that processes a print job in a connection destination group linking function related to a print release function.

In order to solve the above problem, an image forming system according to an aspect of the present disclosure is an image forming system that includes a plurality of groups, to each of which one or more image forming apparatuses operating as parent devices and one or more image forming apparatuses operating as child devices belong, and performs image forming using the image forming apparatus belonging to a group of the plurality of groups configured, the image forming system including: a display that displays a basic screen receiving an instruction to operate the image forming apparatus; and one or more controllers that control a screen display of the basic screen, wherein the one or more controllers display on the basic screen a switching key receiving an instruction to switch to the group designated by a user, and output from the child device a print image based on a print job registered in the parent device belonging to the group after switching.

Further, an image forming apparatus according to an aspect of the present disclosure is an image forming apparatus operating as a parent device or a child device in a system that includes a plurality of groups, to each of which one or more parent devices and one or more child devices belong, and performs image formation using one group selected from among the plurality of groups, the image forming apparatus including: a display that displays a basic screen receiving an instruction to operate from a user; and one or more controllers that control a screen display of the basic screen, wherein the one or more controllers display on the basic screen a switching key receiving an instruction to switch to the group designated by the user.

Further, a method for controlling an image forming system according to an aspect of the present disclosure is a method for controlling an image forming system that includes a plurality of groups, to each of which one or more image forming apparatuses operating as parent devices and one or more image forming apparatuses operating as child devices belong, and performs image forming using the image forming apparatus belonging to a group of the plurality of groups configured, the method including: displaying a basic screen receiving an instruction to operate the image forming apparatus; controlling a screen display of the basic screen; and displaying on the basic screen a switching key receiving an instruction to switch to the group designated by a user, and outputting from the child device a print image based on a print job registered in the parent device belonging to the group after switching.

According to an aspect of the present disclosure, it is possible to provide an image forming system, an image forming apparatus, and a control method for an image forming system capable of easily switching a group that processes a print job in a connection destination group linking function related to a print release function.

### BRIEF DESCRIPTION OF THE DRAWINGS

FIG. 1 is a diagram illustrating a connection form of an image forming system according to a first embodiment.

FIG. 2 is a diagram illustrating an overall configuration of a multifunction device according to the first embodiment.

FIG. 3 is a diagram illustrating a functional configuration of the multifunction device according to the first embodiment.

FIG. 4 is a flowchart illustrating a processing flow according to the first embodiment.

FIG. 5 is a flowchart illustrating a processing flow according to the first embodiment.

FIG. 6 is a diagram illustrating an example of operation according to the first embodiment.

FIG. 7 is a diagram illustrating an example of operation according to the first embodiment.

FIG. 8 is a diagram illustrating an example of operation according to the first embodiment.

FIG. 9 is a diagram illustrating an example of operation according to the first embodiment.

FIG. 10 is a diagram illustrating an example of operation according to the first embodiment.

FIG. 11 is a diagram illustrating an example of operation according to the first embodiment.

FIG. 12 is a diagram illustrating an example of operation according to the first embodiment.

FIG. 13 is a diagram illustrating an example of operation according to a second embodiment.

FIG. 14 is a diagram illustrating an example of operation according to a third embodiment.

FIG. 15 is a diagram illustrating an example of operation according to the third embodiment.

FIG. 16 is a diagram illustrating the related art.

FIG. 17 is a diagram illustrating the related art.

### DETAILED DESCRIPTION OF THE INVENTION

Hereinafter, embodiments of the present disclosure will be described with reference to the drawings. The following embodiments are examples for explaining the present disclosure, and technical content of the description in the claims is not limited to the following description.

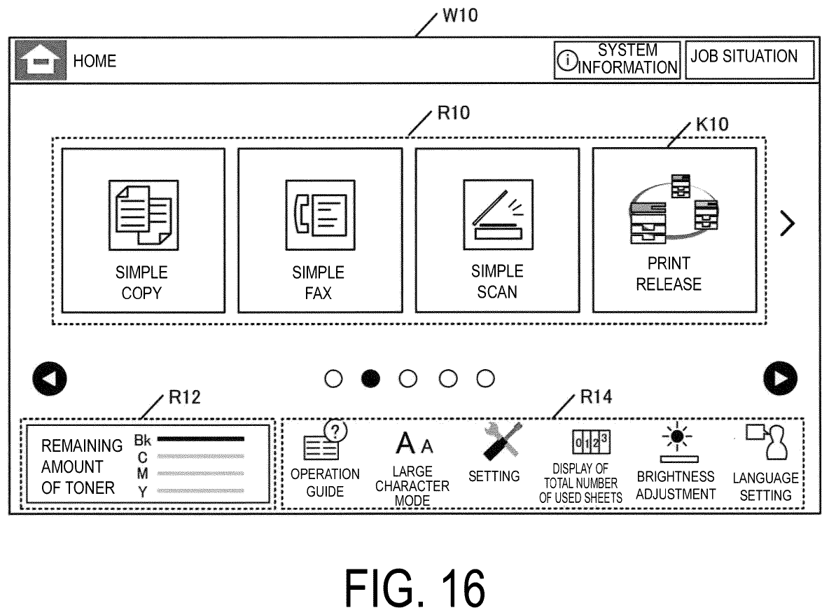

Normally, an image forming apparatus displays a home screen W10 as illustrated in FIG. 16, for example, at the time of power-on, standby, or recovery from a sleep state. The home screen W10 is a basic screen that receives operation inputs from a user and, for example, an instruction to select a shortcut key (a function selection icon) displayed in a shortcut key display region R10 is received such that transition to each operation mode assigned to the shortcut key (transition to a function setting screen) can occur.

Here, the home screen W10 illustrated in FIG. 16 is an example in which the shortcut key display region R10 that displays shortcut keys corresponding to respective operation modes (functions), such as simple copy, simple fax, simple scan, and print release, is included. The shortcut keys displayed in the shortcut key display region R10 are configured to be able to be set and changed via an editing screen that receives an instruction to edit a display configuration of the home screen W10.

In the home screen W10, an information display region R12 and a setting display region R14 may be provided, in addition to the shortcut key display region R10. The information display region R12 is a display region that displays various types of information corresponding to operating states of the device, such as a remaining amount of consumables such as a remaining amount of toner and a remaining amount of paper, content of device settings, and a communication situation. Further, the setting display region R14 is a display region that displays respective setting items related to confirming and changing settings of the image forming apparatus. FIG. 16 illustrates an example in which “operation guide”, “large character mode”, “settings”, “display of total number of used sheets”, “brightness adjustment”, and “language settings” are provided as settable items in the setting display region R14. The display region of the shortcut key display region R10 can be expanded from one row and four columns illustrated in FIG. 16 to two rows and four columns to increase the number of selectable shortcut keys, instead of the information display region R12 and the setting display region R14 in the home screen W10. The display configuration of the home screen W10 can be changed appropriately depending on display capability of a display device included in the image forming apparatus or content of settings made by an administrator (user).

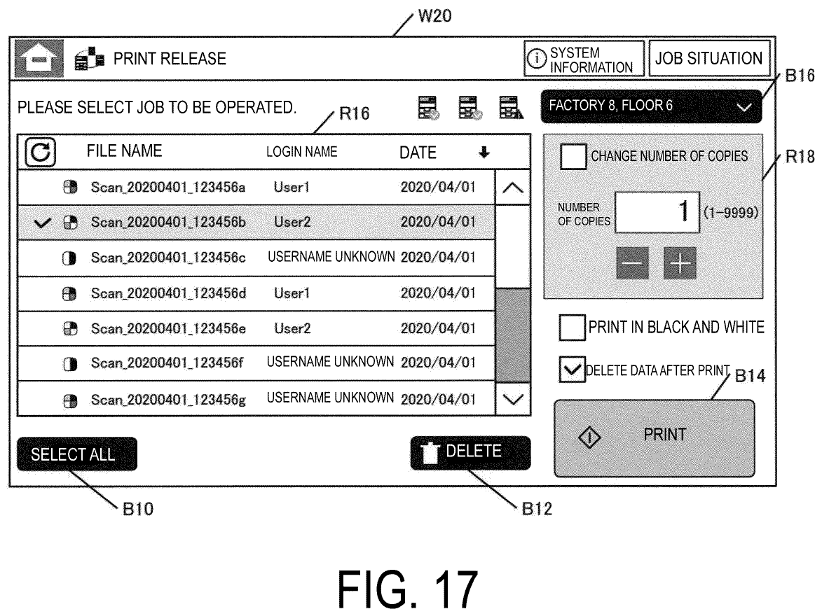

Here, FIG. 17 illustrates an example of a configuration of a print release screen W20 displayed by the image forming apparatus when an instruction to select a shortcut key K10 (print release key K10) displayed in the shortcut key display region R10 is received by the user.

The print release screen W20 illustrated in FIG. 17 includes a job selection region R16, a number-of-print-copies setting region R18, an all-selection button B10, a deletion button B12, a print button B14, and a connection destination selection button B16.

The job selection region R16 is a display region that displays print jobs registered in the image forming apparatus that operates as a parent device. When a connection destination group linking function is disabled in the print release function or when a connection destination group is not changed, print jobs registered in the image forming apparatus (parent device) belonging to a default (initially set) group are displayed.

The all-selection button B10 is a button that receives an instruction to select all of the print jobs displayed in the job selection region R16. The deletion button B12 is a button that receives an instruction to delete the print job selected by the user. The print button B14 is a button that receives an instruction to execute the print job selected by the user. The number-of-print-copies setting region R18 is a region for receiving an instruction to set or change the number of print copies from the user.

The connection destination selection button B16 is a button that receives an instruction to switch the connection destination groups when the connection destination group linking function is enabled in the print release function. When the user changes the connection destination group, for example, from the default group, the user needs to switch the connection destination group via the connection destination selection button B16.

Thus, in the related art, when the connection destination group related to the print release function is switched from a currently set group to another group, the user needs to select the shortcut key K10 on the home screen W10 illustrated in FIG. 16 to display the print release screen W20 illustrated in FIG. 17 and then switch to a desired group via the connection destination selection button B16 on the print release screen W20, and cannot directly perform an operation of switching to the desired group in the home screen W10.

In the present disclosure, an image forming system (image forming apparatus) capable of easily switching a group that processes a print job in the connection destination group linking function of the print release function is realized in embodiments below.

### 1 First Embodiment

### 1.1 Functional Configuration

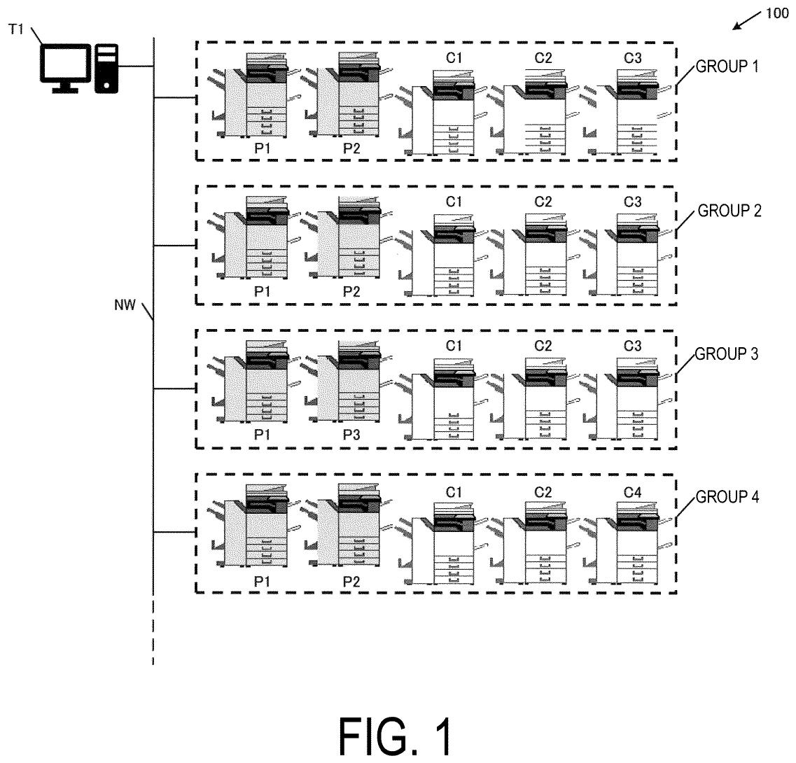

FIG. 1 is a diagram illustrating an example of a connection form of an image forming system 100 according to a first embodiment. In the image forming system 100, image forming apparatuses P1 and P2 operating as parent devices and image forming apparatuses C1, C2, and C3 operating as child devices belong to one group (for example, Group 1 or Group 2), image forming apparatuses P1 and P3 operating as parent devices and the image forming apparatuses C1, C2, and C3 operating as child devices belong to one group (for example, Group 3), the image forming apparatuses P1 and P2 operating as parent devices and image forming apparatuses C1, C2, and C4 operating as child devices belong to one group (for example, Group 4), and the groups 1 to 4 are connected via a network NW.

The parent device is an image forming apparatus that can store a print job output from an information processing device T1 or a print job based on document information, image information, or the like acquired by other means (for example, by reading data from a universal series bus (USB) memory or the like) and output the print job in response to an acquisition request from a child device. In FIG. 1, a form in which the two image forming apparatuses P1 and P2 or P3 as parent devices are included in one group is illustrated, but one or more parent devices may be included in one group and the number of parent devices is not limited.

The child device is an image forming apparatus that can output, to a sheet-like medium, a print image based on the print job acquired in response to the acquisition request output to the parent device. In FIG. 1, a form in which three image forming apparatuses C1, C2, and C3 or C4 as child devices are included in one group is illustrated, but one or more child devices may be included in one group and the number of child devices is not limited.

The information processing device T1 is an information processing device that includes, for example, document creation software or chart drawing software, and is capable of outputting document information or image information created using the software to the parent device as a print job. The information processing device T1 is an information processing device that is mainly used by a user who wishes to acquire a print image based on a print job. Since, for example, a general information processing device distributed in a market, such as a personal computer (PC), tablet, or smartphone, can be used for the information processing device T1, detailed description will be omitted here.

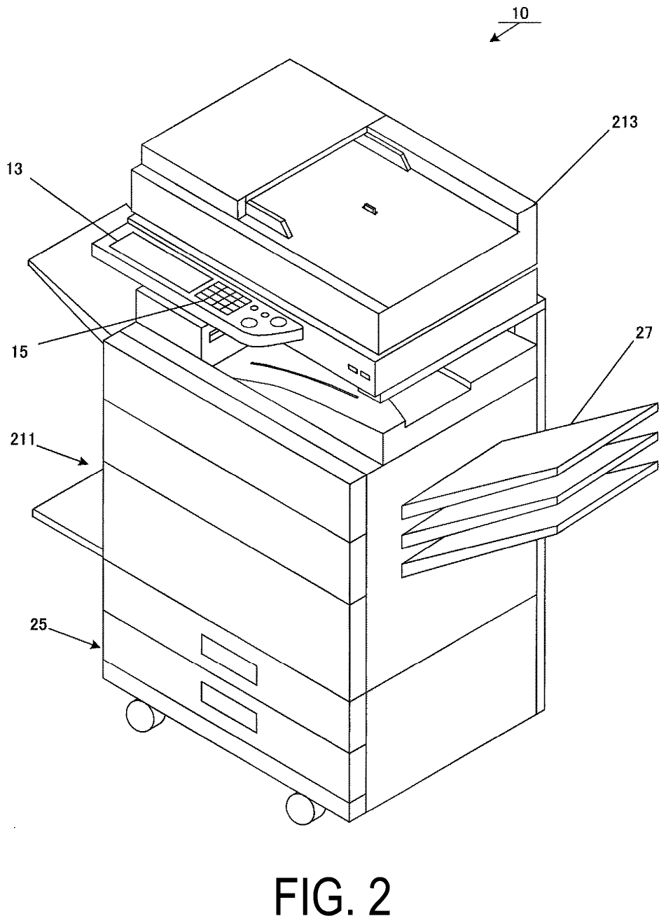

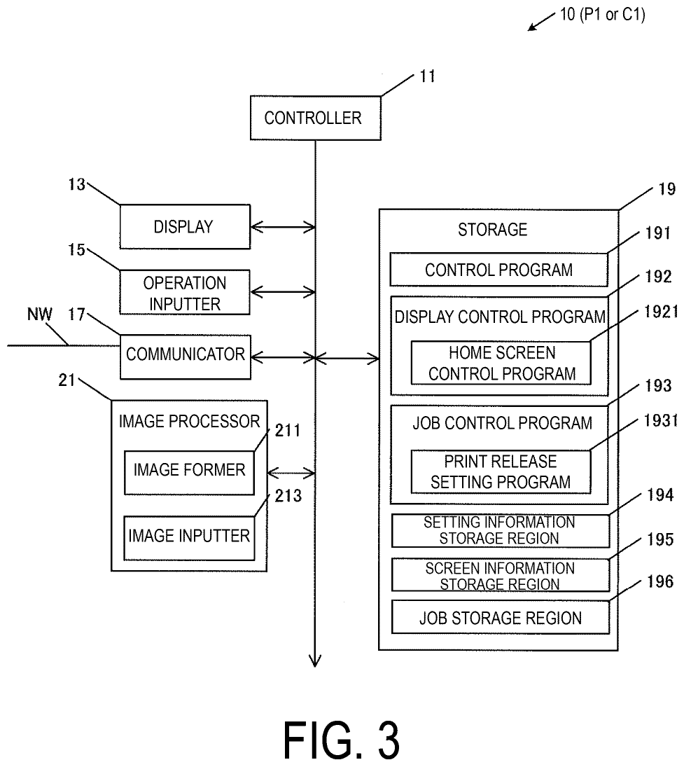

FIG. 2 is a diagram illustrating an overall configuration of the multifunction device 10 as the image forming apparatus. FIG. 3 is a functional configuration diagram of the multifunction device 10. Since the multifunction devices (image forming apparatuses P1, P2, and P3) operating as the parent device and the multifunction devices (image forming apparatuses C1, C2, C3, and C4) operating as child devices according to the present disclosure can have substantially the same configuration, no distinction is made between the parent device and the child device, and the parent device and the child device will be described as the multifunction device 10.

The multifunction device 10 is an image forming apparatus capable of executing various types of jobs, such as a print job, copy job, scan job, fax job, and image transmission job, in a single housing. In the present disclosure, an example of the multifunction device will be described as one form of the image forming apparatus, but the image forming apparatus is not limited to the multifunction device and may be, for example, a printer, copier, or fax machine with each limited job function.

Such a multifunction device 10 includes a controller 11, a display 13, an operation inputter 15, a communicator 17, a storage 19, and an image processor 21.

The controller 11 generally controls the multifunction device 10. The controller 11 can be configured of one or more computation devices (for example, a central processing unit (CPU) or a system on chip (SoC)). The controller 11 realizes its functions by reading and executing various programs stored in the storage 19.

The display 13 is a display device that displays various pieces of information to the user or the like. The display 13 can be configured of, for example, a liquid crystal display (LCD), an organic electro-luminescence (EL) display, or the like. The display 13 displays, for example, an operation screen such as a home screen or a setting screen related to each operation mode.

The operation inputter 15 is an input device that receives information input by the user or the like. The operation inputter 15 can be configured of, for example, various input devices such as operation keys such as hardware keys and software keys, and buttons. The operation inputter 15 can be configured as a touch panel that can receive input via the display 13. When the operation inputter 15 is configured as the touch panel, the operation inputter 15 can detect a user's touch, tap, swipe, or the like with respect to an object displayed via the display 13, and can acquire a coordinate position, pressure-sensitive information, or the like of touch panel information. In this case, an input scheme for the touch panel can be a general input scheme such as a resistive film scheme, an infrared scheme, an electromagnetic induction scheme, or a capacitive scheme.

The communicator 17 includes a wired interface, a wireless interface, or a wired and wireless interface for communication with the multifunction device 10 belonging to the same group or another group or the information processing device T1 via a network NW such as a local area network (LAN), a wide area network (WAN), the Internet, a telephone line, or a FAX line. Further, the communicator 17 may also include an interface for short-range wireless communication technology such as Bluetooth (registered trademark), near field communication (NFC), Wi-Fi (registered trademark), ZigBee (registered trademark), infrared data association (IrDA), and a wireless universal serial bus (USB).

The storage 19 is one or more storage devices that store various programs and various pieces of data required for operation of the multifunction device 10. The storage 19 can be configured of a storage device such as a random access memory (RAM), a solid state drive (SSD), a hard disk drive (HDD), and a read only memory (ROM).

In the first embodiment, the storage 19 stores a control program 191, a display control program 192, and a job control program 193, and secures a setting information storage region 194, a screen information storage region 195, and a job storage region 196.

The control program 191 is a program that the controller 11 reads after the device starts. The controller 11 that reads the control program 191 functions as an operating system (OS) to control driving of hardware such as the display 13, the operation inputter 15, the communicator 17, and the image processor 21.

The display control program 192 is a program that the controller 11 reads when controlling an output of the operation screen displayed on the display 13 or the operation inputter 15 configured as a touch panel. The display control program 192 includes a home screen control program 1921. The controller 11 reading the home screen control program 1921 receives an instruction to edit the display configuration of the home screen W10 from the user via an editing screen to be described below. The controller 11 determines the display configuration of the home screen W10 based on the editing instruction received from the user, and displays the home screen W10 on the display 13 (the operation inputter 15).

The job control program 193 is a program that the controller 11 reads when executing a print job related to printing, copying, or the like, or a job related to faxing or image transmission. The controller 11 that reads the job control program 193 transitions to an operation mode for executing each job (for example, a simple copy mode, a simple fax mode, a simple scan mode, or a print release mode) and executes the job. Further, when the controller 11 executes a job, the controller 11 can display an operation screen that receives a selection of a setting value or function required for execution of the job from the user, on the touch panel as necessary. The controller 11 can execute the job based on the setting value or function received via the operation screen.

Further, the job control program 193 includes a print release setting program 1931. The controller 11 that reads the print release setting program 1931 receives, via a print release setting screen to be described later, connection destination group function extension by a user, a setting of a group that is used by default and a connection destination group, and a designation of a group to be displayed in the shortcut key display region R10 of the home screen W10. Further, the controller 11 executes a series of processes related to the print release, such as a process of switching a group to be used for the print release.

The setting information storage region 194 is a storage region for storing, for example, device settings in the multifunction device 10 (for example, settings or designation content received via the print release setting program 1931), setting values required for execution of each job received via the operation screen, and selection information for each function.

The screen information storage region 195 is a storage region for storing display content necessary for displaying, for example, the home screen W10 and an operation screen for executing each job.

The job storage region 196 is a storage region for storing a print job acquired from the information processing device T1 and print job based on, for example, document information or image information acquired via the USB memory or an image inputter 213, which will be described later.

The image processor 21 includes an image former 211 and the image inputter 213. The image former 211 receives paper fed as a sheet-like medium from a paper feeder 25, forms an image based on image data on the paper, and then discharges the paper to a paper discharger 27. The image former 211 can be configured, for example, of a laser printer using an electrophotographic scheme.

The image inputter 213 generates image information by scanning a document. The image inputter 213 can be configured as a scanner device including an automatic document feeder (ADF), a flatbed for placing and reading a document, and the like, in addition to an image sensor such as a charge coupled device (CCD) or a contact image sensor (CIS). There is no particular limitation on a configuration of the image inputter 213, as long as the image inputter 213 can generate image information by reading a reflected light image from a document image with an image sensor. The image inputter 213 can also be configured as an interface capable of acquiring image information stored in a storage medium such as a USB memory or image information transmitted from the information processing device T1. The image processor 21 may be configured to generate image information for data transmission by performing, for example, shading correction or density correction on the image information input from the image inputter 213.

### 1.2 Processing Flow

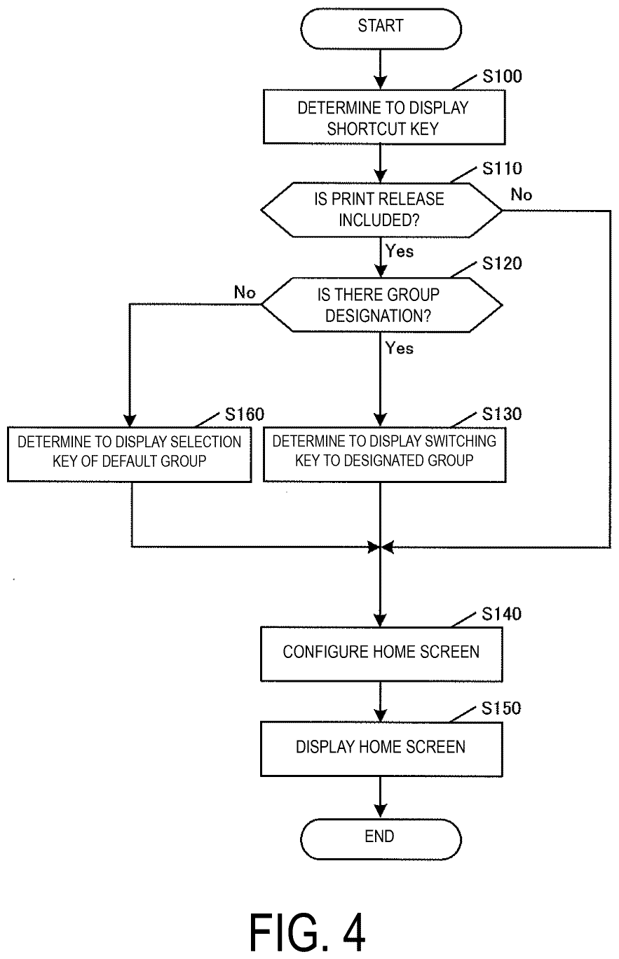

Next, a processing flow according to the first embodiment will be described. FIG. 4 is a flowchart illustrating a process related to a display of the home screen W10 in the child devices C1, C2, C3, and C4 belonging to any one of groups 1 to 4. The process described with reference to FIG. 4 is a process that is executed by the controller 11 reading the control program 191, the display control program 192 (home screen control program 1921), and the like. A flow of a process executed by the multifunction device 10 operating as a child device will be described with reference to FIG. 4, but the flow of the process can also be executed by the multifunction device 10 operating as a parent device.

The controller 11 starts a process of displaying the home screen W10 at an appropriate timing, such as at the time of power-on, standby, or recovery from a sleep state. When the process of displaying the home screen W10 starts, the controller 11 performs a determination process for determining which operation mode the shortcut keys assigned to is displayed in the shortcut key display region R10 (step S100).

The controller 11 determines whether the shortcut keys displayed in the shortcut key display region R10 include a shortcut key related to the print release (step S110). When it is determined that the shortcut keys displayed in the shortcut key display region R10 include the shortcut key related to the print release, the controller 11 determines whether the group to be displayed in the shortcut key display region R10 is designated by the user (step S110; in a case of Yes, proceeding to step S120). On the other hand, when it is determined that the shortcut keys displayed in the shortcut key display region R10 do not include the shortcut key related to the print release, the controller 11 configures the home screen W10 in which shortcut keys other than the shortcut key related to the print release are included in the shortcut key display region R10 (step S110; in a case of No, proceeding to step S140). The controller 11 displays the configured home screen W10 on the display 13 (the operation inputter 15) and ends the process (step S150).

When it is determined in step S120 that the group to be displayed in the shortcut key display region R10 is designated by the user, the controller 11 determines a display of a switching key that receives an instruction to switch to the designated group (step S120; in a case of Yes, proceeding to step S130).

Then, the controller 11 configures the home screen W10 in which the switching key determined in step S130 is included in the shortcut key display region R10 (step S140). The controller 11 displays the configured home screen W10 on the display 13 (the operation inputter 15) and ends the process (step S150).

On the other hand, when it is determined that the group to be displayed in the shortcut key display region R10 is not designated by the user, the controller 11 determines to display a selection key that receives an instruction to select the group that is used by default (step S120; in a case of No, proceeding to step S160).

The controller 11 configures the home screen W10 in which the selection key determined in step S160 is included in the shortcut key display region R10 (step S140). The controller 11 displays the configured home screen W10 on the display 13 (the operation inputter 15) and ends the process (from step S150 to “End”).

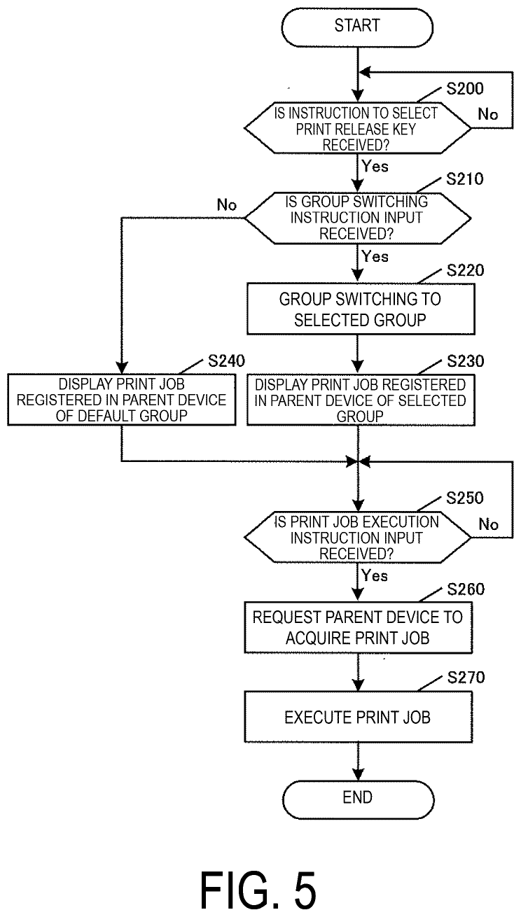

Next, a process of receiving the selection of the shortcut key related to the print release displayed on the home screen W10 and executing the print job will be described using the flowchart in FIG. 5. The process described with reference to FIG. 5 is a process in which the controller 11 of the child device C1, C2, C3, or C4 belonging to any one of groups 1 to 4 reads and executes the control program 191, the display control program 192 (home screen control program 1921), the job control program 193 (the print release setting program 1931), and the like.

The controller 11 determines whether or not an instruction to select the shortcut key (print release key) related to the print release has been received via the home screen W10 (step S200). When it is determined that the instruction to select the print release key has been received, the controller 11 determines whether or not the instruction to select is related to a group switching instruction (step S200; in a case of Yes, proceeding to step S210). When it is determined that the instruction to select the print release key has not been received, the controller 11 waits until the instruction to select the print release key is received (step S200; No). Although not shown, when a shortcut key other than the print release key is selected by the user, it is also possible to execute a process related to an operation mode (function) assigned to the shortcut key.

When it is determined that the selection instruction from the user is related to the group switching instruction, the controller 11 performs processing for group switching to the selected group (step S210; in a case of Yes, proceeding to step S220).

After the processing for switching to the selected group, the controller 11 acquires print jobs registered in the parent device belonging to the group, and displays the acquired print jobs in the job selection region R16 of the print release screen W20 (step S230).

On the other hand, when it is determined in step S210 that the selection instruction from the user is not related to the group switching instruction, the controller 11 determines that the selection instruction from the user is related to a default group selection instruction, acquires print jobs registered in the parent device belonging to the default group, and displays the acquired print jobs in the job selection region R16 of the print release screen W20 (step S210; in a case of No, proceeding to step S240).

Next, the controller 11 determines whether or not an execution instruction from the user for the print job displayed in the job selection region R16 has been received (step S250). When it is determined that an input of an instruction to execute a print job from the user has been received, the controller 11 requests the parent device belonging to a currently selected group to acquire the print job (step S250; in a case of Yes, proceeding to step S260).

The controller 11 executes the print job acquired from the parent device and ends the process (from step S270 to “End”). When it is determined that the instruction to execute a print job from the user has not been received, the controller 11 waits until an input instruction for the instruction to execute is received (step S250; No).

The processes related to steps S200 to S220 can also be executed by the controller 11 of the parent device P1, P2, or P3 belonging to any one of groups 1 to 4.

### 1.3 Example of Operation

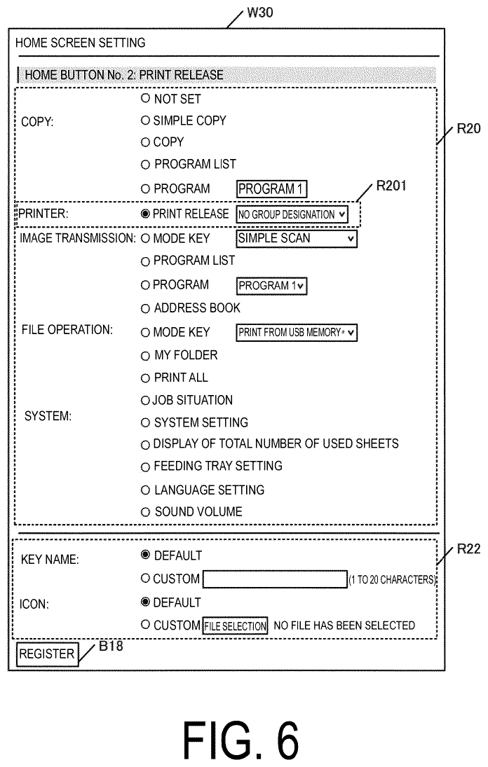

Next, an example of operation according to the first embodiment will be described. FIG. 6 illustrates an example of a configuration of a home screen setting screen W30 serving as an editing screen that receives an instruction to edit the display configuration of the home screen W10. The home screen setting screen W30 includes a shortcut key selection region R20, a key name and other setting region R22, and a registration button B18.

The shortcut key selection region R20 is a region for receiving an instruction to select, for example, a shortcut key that the user wishes to display in the shortcut key display region R10 of the home screen W10, various types of information that the user wishes to display in the information display region R12, and (setting) items that the user wishes to display in the setting display region R14. In the shortcut key selection region R20, a print release selection region R201 for receiving an instruction to display the shortcut key related to the print release is provided.

The print release selection region R201 includes a radio button for receiving a setting of enabling/disabling the display of the shortcut key K10 (print release key K10) related to the print release, and a pull-down menu for receiving the selection of a group that processes the print job. FIG. 6 illustrates a case where the display of the shortcut key K10 related to the print release is set to “enabled”, and an example in which a group used by default (no group designation) is designated as the group that processes the print job.

The key name and other setting region R22 is a region for receiving settings of, for example, a key name and an icon of the shortcut key K10 related to the print release that is displayed in the shortcut key display region R10. FIG. 6 illustrates an example in which “default” is set as the name and the icon of the shortcut key K10. When “default” is set as the key name, a name (print release) of an operation mode assigned to the shortcut key K10 is displayed, but it is possible to change the name by selecting a custom radio button and inputting a desired name.

The registration button B18 is a button that receives an instruction to confirm content of selection and setting in the shortcut key selection region R20 and the key name and other setting region R22.

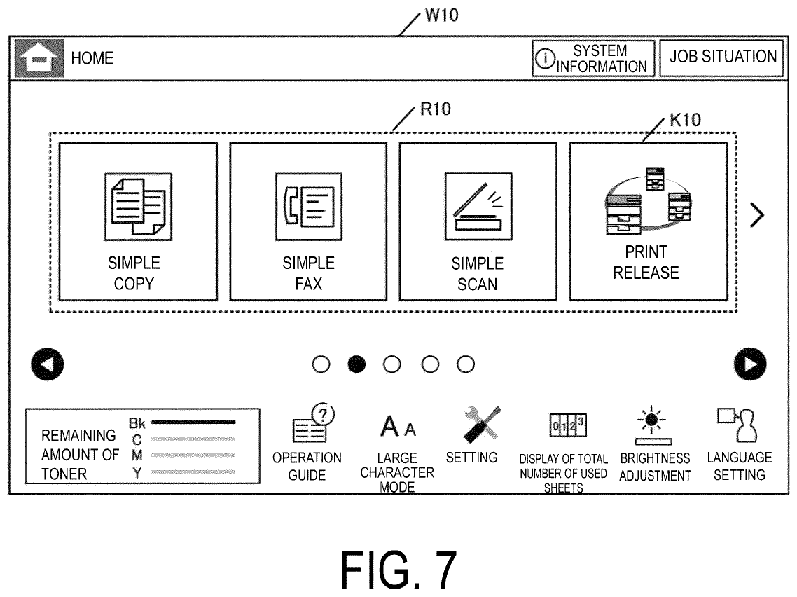

FIG. 7 illustrates an example of a configuration of a home screen W10 whose display configuration has been edited via the home screen setting screen W30. The home screen W10 illustrated in FIG. 7 is an example in which the shortcut key K10 related to the print release is provided in the shortcut key display region R10. Since the display configuration of the home screen W10 illustrated in FIG. 7 can be the same as the home screen W10 described with reference to FIG. 16, description will be omitted here.

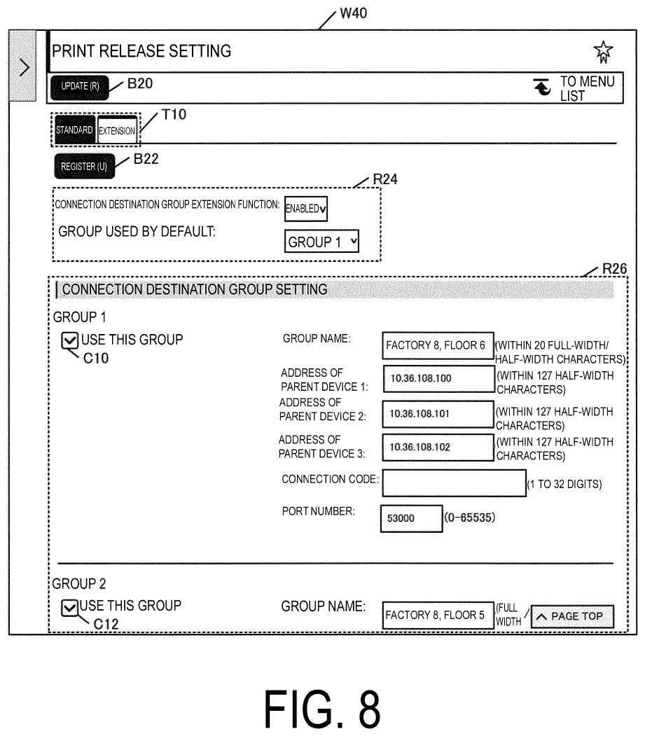

FIG. 8 illustrates an example of a configuration of a print release setting screen W40. The print release setting screen W40 includes an update button B20, a function selection tab T10, a registration button B22, a connection destination group extension function setting region R24, and a connection destination group setting region R26.

The update button B20 is a button that receives input of an update instruction to update a print release setting with content that has been set via the print release setting screen W40.

The function selection tab T10 includes a standard function tab and an extension tab, and is a tab that receives an instruction to switch functions that are set via the print release setting screen W40. FIG. 8 illustrates an example in which the extension tab is selected by the user and a setting screen related to the connection destination group extension function as an extension function is displayed.

The registration button B22 is a button that receives an instruction to register content of settings made in the connection destination group extension function setting region R24 and the connection destination group setting region R26.

The connection destination group extension function setting region R24 includes a pull-down menu that receives an instruction to set enable/disable of the connection destination group extension function as an extension function, and a pull-down menu that receives the instruction to select the group that is used by default. FIG. 8 illustrates an example in which the connection destination group extension function is set to “enabled” and “Group 1” is selected as the group that is used by default.

The connection destination group setting region R26 is a region for receiving input of connection information of a connection destination group that processes the print job. In the connection destination group setting region R26, a check box C10 that receives whether or not the group is able to be used for print release (application of a use setting) is provided, in addition to an input region where connection information can be input for each group that the user wishes to use.

For example, in a setting region related to “Group 1,” a state in which a check box C10, “Use this group” is checked, “Factory 8, Floor 6,” is set as “Group name”, “10.36.108.100” is set as “Address of parent device 1”, “10.36.108.101” is set as “Address of parent device 2, “10.36.108.102” is set as “Address of parent device 3”, “Not set” is set as “Connection code”, and “53000” is set as “Port number” is shown.

In a setting region related to “Group 2,” a state in which a check box C12, “Use this group” is checked and “Factory 8, Floor 5” is set as “Group name” is shown. Connection information after “Address of parent device 1” will be omitted due to space limitations.

Incidentally, FIG. 8 shows an example of input of the connection information for two groups including “Group 1” and “Group 2” as connection destination groups that process the print job, but the number of set connection destination groups (the number of registered connection destinations) is not particularly limited.

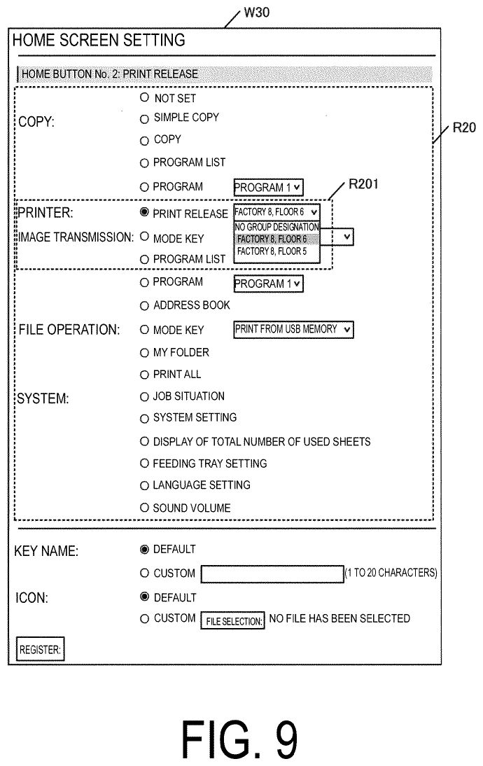

FIG. 9 illustrates an example of a configuration of the home screen setting screen W30 that the controller 11 displays based on content of settings made via the print release setting screen W40 described with reference to FIG. 8. FIG. 9 illustrates an example in which “Factory 8, Floor 6” set as “Group 1” is displayed to be selectable in the print release selection region R201 of the home screen setting screen W30.

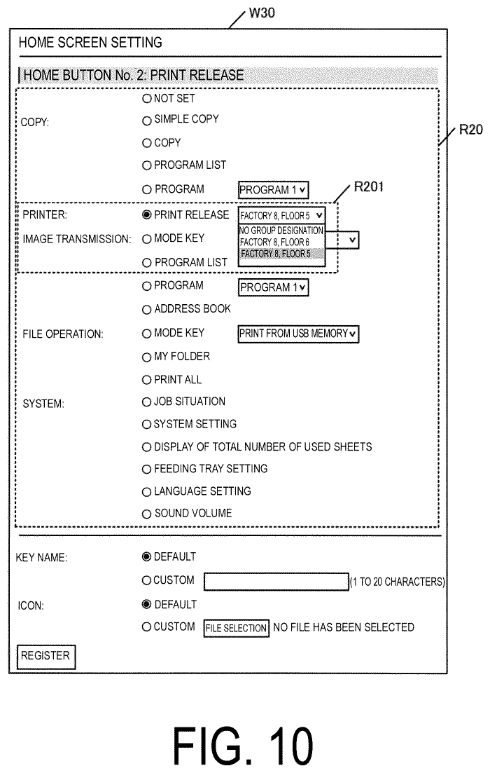

Similarly, FIG. 10 illustrates an example of a configuration of the home screen setting screen W30 that the controller 11 displays based on content of settings made via the print release setting screen W40 described with reference to FIG. 8. FIG. 10 illustrates an example in which “Factory 8, Floor 5” set as “Group 2” is displayed to be selectable in the print release selection region R201 of the home screen setting screen W30.

In the print release selection region R201, when the connection destination group extension function is set to “enabled” in the connection destination group extension function setting region R24 of the print release setting screen W40 described in FIG. 8 and the check box C10, “Use this group”, of “Group 1” and/or the check box C12, “Use this group”, of “Group 2” in the connection destination group setting region R26 of the print release setting screen W40 is checked, a “group name” assigned to the group is displayed.

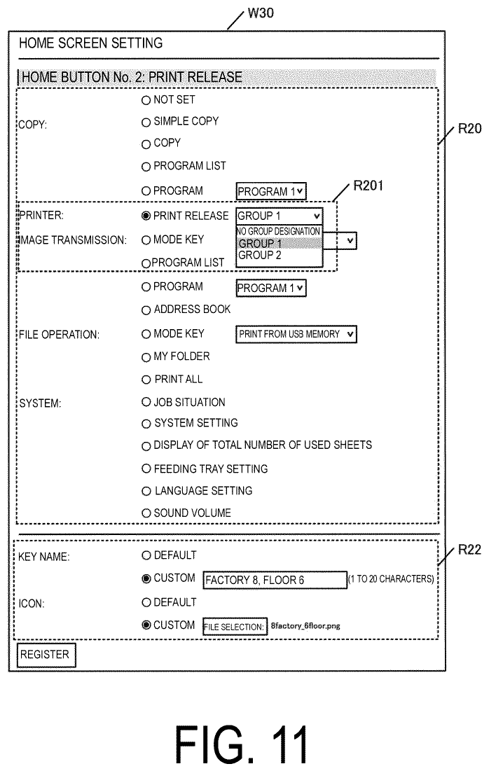

Incidentally, even when an appropriate “group name” is not assigned in the connection destination group setting region R26 of the print release setting screen W40, it is also possible to select the group that processes the print job in the home screen setting screen W30. In this case, as illustrated in FIG. 11, the print release selection region R201, “Group 1” or “Group 2” is displayed to be selectable as the group that processes the print job, and when the user wishes to assign a “group name” to the “Group 1” or “Group 2”, it is possible to assign the name of “Group 1” or “Group 2” in the key name and other setting region R22.

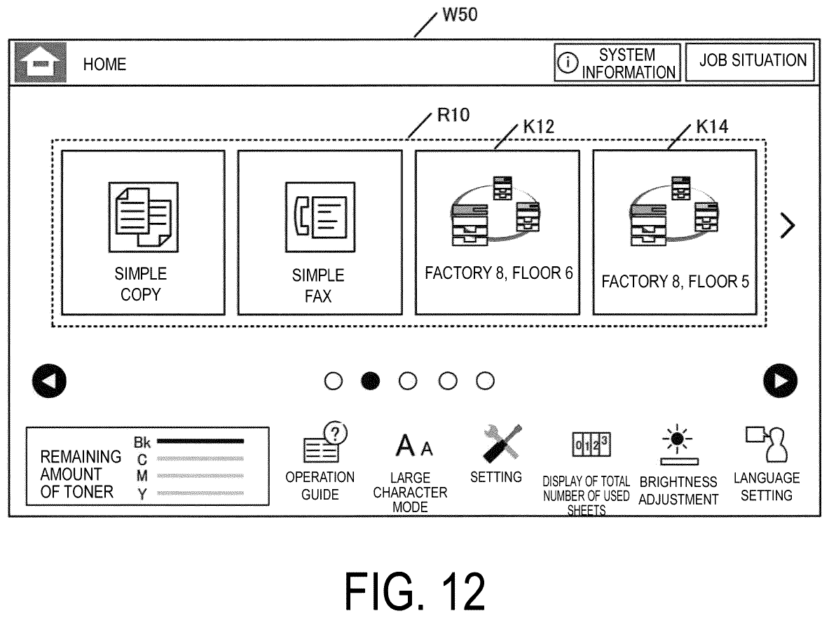

FIG. 12 illustrates an example of a configuration of a home screen W50 edited via the home screen setting screen W30 illustrated in FIGS. 9 to 11. The home screen W50 illustrated in FIG. 12 illustrates an example in which a shortcut key K12 corresponding to “Group 1” and a shortcut key K14 corresponding to “Group 2” are displayed in the shortcut key display region R10 as the shortcut keys related to the print release.

As described above, according to the first embodiment, it is possible to dispose a plurality of shortcut keys assigned to different groups on the home screen when a connection destination group extension function of the print release is used, making it easy to directly switch to the group that processes the print job.

### 2 Second Embodiment

A second embodiment is a form in which each shortcut key is displayed in an identifiable manner when a plurality of shortcut keys assigned to the print release are arranged (displayed) on the home screen in the first embodiment.

Since a functional configuration and processing flow of the image forming system 100 (multifunction device 10) according to the second embodiment can be the same as those of the first embodiment, description thereof will be omitted here.

### 2.1 Example of Operation

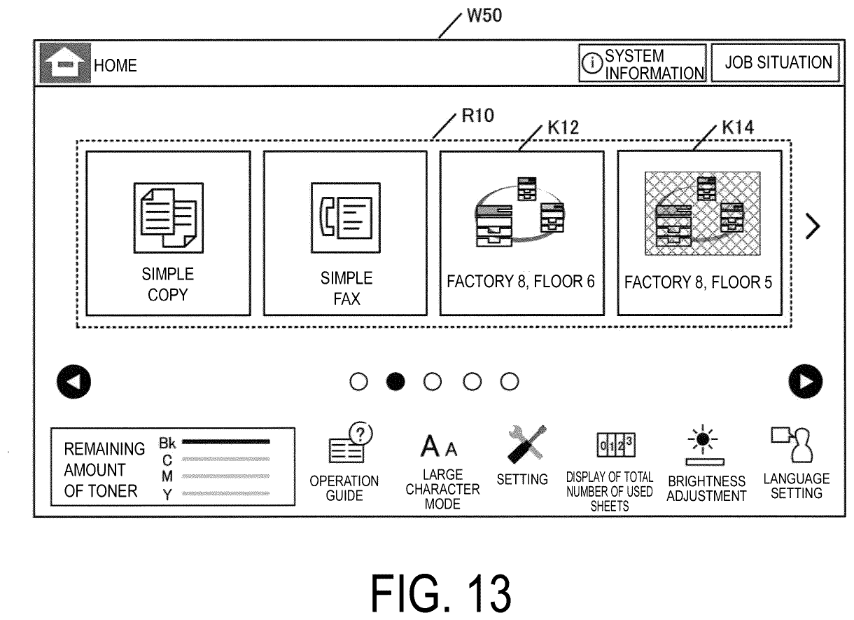

FIG. 13 illustrates an example in which the shortcut keys K12 and K14 assigned to the print release described in the first embodiment are displayed in different display colors. In FIG. 13, locations with different display colors are represented by crosshatching to show the different display colors.

In the second embodiment, as long as each shortcut key can be displayed in an identifiable manner, the display is not limited to displaying the shortcut keys in different display colors, and for example, display control may be performed to display a font, font size, icon, or the like representing the name of each shortcut key in an identifiable manner.

As described above, according to the second embodiment, when a plurality of shortcut keys assigned to print release are arranged on the home screen, the user can easily identify a switching destination group, in addition to the effects of the first embodiment.

### 3 Third Embodiment

A third embodiment is a form in which changing a name (“group name”) of the shortcut key is restricted when, in the first embodiment, a specific multifunction device 10 (for example, the parent device P1) is caused to have a management authority, and the “group name” set in the multifunction device 10 is allowed to be synchronized with other multifunction devices 10 (for example, the parent device P2 and the child devices C1, C2, and C3).

Since a functional configuration and processing flow of an image forming system 100 (multifunction device 10) according to the third embodiment can be the same as those in the first embodiment, description thereof will be omitted here.

### 3.1 Example of Operation

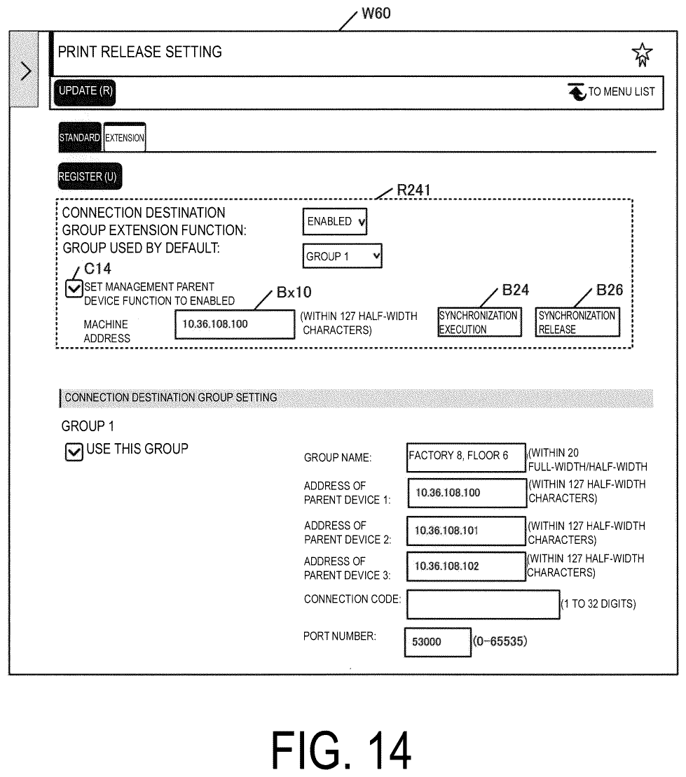

FIG. 14 is a diagram illustrating an example of a display configuration of a print release setting screen W60 according to the third embodiment. The print release setting screen W60 illustrated in FIG. 14 includes a connection destination group extension function setting region R241 including a management parent device function check box C14, an address input box Bx10, a synchronization execution button B24, and a synchronization release button B26, in addition to the configuration of the connection destination group extension function setting region R24 described with reference to FIG. 8 and other figures.

The management parent device function check box C14 is a check box that receives an instruction to set enable/disable of the management parent device function for assigning a management authority. The address input box Bx10 is an input box that receives input of an address (IP address) of the multifunction device 10 that is set as the management parent device. The synchronization execution button B24 is a button that receives input of a synchronization start instruction when the “group name” set in the multifunction device 10 that is the management parent device is synchronized with another multifunction device 10, and the synchronization release button B26 is a button that receives input of a synchronization release instruction when the synchronization of the “group name” is released.

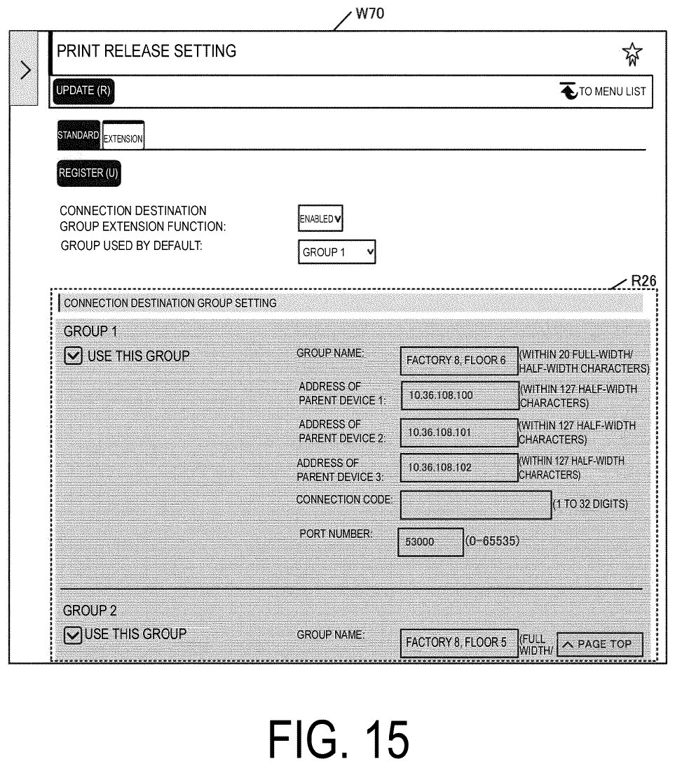

FIG. 15 is a diagram illustrating an example of a display configuration of a print release setting screen W70 in another multifunction device 10 to be synchronized, when the synchronization of the “group name” set in the multifunction device 10 that is the management parent device is started.

As shown in the example of FIG. 15, when synchronization with the management parent device is started, changing the name (“group name”) of the shortcut key is restricted in the other multifunction device 10 to be synchronized. FIG. 15 illustrates a form in which changing a “group name” is restricted, and the connection destination group setting region R26 in the print release setting screen W70 is displayed in a darkened state so that input to the region is disabled.

As described above, according to the third embodiment, when the “group name” set in the multifunction device 10 with management authority can be synchronized with the other multifunction device 10, changing the name (“group name”) of the shortcut key is restricted, making it possible to prevent a user operating the other multifunction device 10 from accidentally changing the name of the shortcut key, in addition to the effects of the first embodiment.

The present disclosure is not limited to the above-described embodiments, and various modifications are possible. In other words, the technical scope of the present disclosure also includes embodiments obtained by combining technical means that are appropriately modified within the scope of the gist of the present disclosure.

Further, although the above-described embodiments are described separately for convenience of description, it is obvious that the embodiments may be executed in combination within a technically possible scope.

Further, in the embodiment, a program operating on each device is a program that controls a CPU or the like (a program for causing a computer to function) to realize the functions of the above-described embodiment. Information handled by such a device is temporarily stored in a temporary storage device (for example, a RAM) during processing and then stored in various storage devices such as read only memories (ROMs) and HDDs, and is read, modified, and written by the CPU as necessary.

Here, a computer-readable non-transitory recording medium on which the program is recorded in the information processing device may be any of a semiconductor medium (for example, a ROM or a non-volatile memory card), an optical recording media/magnetic optical recording medium (for example, a digital versatile disc (DVD), magneto optical disc (MO), mini disc (MD), compact disc (CD), Blu-ray (BD; registered trademark) disc), or the like), a magnetic recording medium (for example, a magnetic tape or flexible disk), and the like. In this case, the program recorded on the recording medium is read by the computer of the information processing device and executed by the computer, so that not only the functions of the above-described embodiment are realized, but also functions of the present disclosure are realized by performing processing in cooperation with an operating system, another application program, or the like based on instructions of the program.

Further, when a program is distributed in the market, the program can be stored in a portable recording medium and distributed, or can be transferred to a server computer connected via a network such as the Internet. In this case, it is obvious that a storage device of the server computer is also included in the present disclosure.

Further, each functional block or feature of the device used in the above-described embodiment can be implemented and executed by an electric circuit, such as an integrated circuit or a plurality of integrated circuits. The electric circuit designed to realize the functions described herein may include a general-purpose processor, a digital signal processor (DSP), an application-specific integrated circuit (ASIC), a field programmable gate array (FPGA), another programmable logic device, a discrete gate or transistor logic, a discrete hardware component, or a combination thereof. The general-purpose processor may be a microprocessor or may be a processor, controller, microcontroller, or state machine of the related art. The electric circuit described above may be configured of a digital circuit or may be configured of an analog circuit. Further, when an integrated circuit technology for replacement of a current integrated circuit emerges with the development of semiconductor technology, a new integrated circuit based on the technology may also be used in one or more aspects of the present disclosure.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image forming system that includes a plurality of groups, to each of which one or more image forming apparatuses operating as parent devices and one or more image forming apparatuses operating as child devices belong, and performs image forming using the image forming apparatus belonging to a group of the plurality of groups configured, the image forming system comprising:
a display that displays a basic screen receiving an instruction to operate the image forming apparatus; and
one or more controllers that control a screen display of the basic screen, wherein
the one or more controllers
display on the basic screen a switching key receiving an instruction to switch to the group designated by a user, and
output from the child device a print image based on a print job registered in the parent device belonging to the group after switching.

2. The image forming system according to claim 1, wherein
the one or more controllers
display on the display an editing screen receiving an instruction to edit a display configuration of the basic screen, and
receive an instruction to display the switching key on the basic screen via the editing screen.

3. The image forming system according to claim 2, wherein
the one or more controllers receive an instruction to display the switching key corresponding to the group to which a use setting is applied.

4. The image forming system according to claim 1, wherein
when the one or more controllers do not receive an instruction to display the switching key, the one or more controllers display a selection key receiving an instruction to select the group configured as a default on the basic screen.

5. The image forming system according to claim 1, wherein
when the one or more controllers display a plurality of the switching keys on the basic screen, the one or more controllers display the plurality of switching keys so as to be identifiable.

6. The image forming system according to claim 1, wherein
a name of the group is changeable from a name configured as a default.

7. The image forming system according to claim 6, wherein
when an administration privilege for the parent device is configured to be enabled and synchronization with the child device is executed, the one or more controllers restrict change of the name of the group.

8. An image forming apparatus operating as a parent device or a child device in a system that includes a plurality of groups, to each of which one or more parent devices and one or more child devices belong, and performs image formation using one group selected from among the plurality of groups, the image forming apparatus comprising:
a display that displays a basic screen receiving an instruction to operate from a user; and
one or more controllers that control a screen display of the basic screen, wherein
the one or more controllers display on the basic screen a switching key receiving an instruction to switch to the group designated by the user.

9. A method for controlling an image forming system that includes a plurality of groups, to each of which one or more image forming apparatuses operating as parent devices and one or more image forming apparatuses operating as child devices belong, and performs image forming using the image forming apparatus belonging to a group of the plurality of groups configured, the method comprising:
displaying a basic screen receiving an instruction to operate the image forming apparatus;
controlling a screen display of the basic screen; and
displaying on the basic screen a switching key receiving an instruction to switch to the group designated by a user, and outputting from the child device a print image based on a print job registered in the parent device belonging to the group after switching.
